(19) United States
(12) Patent Application Publication
(10) Pub. No.: US 2025/0285652 A1
(43) Pub. Date: Sep. 11, 2025

(54) MAGNETIC DISK APPARATUS

(71) Applicants: Kabushiki Kaisha Toshiba, Tokyo (JP); Toshiba Electronic Devices & Storage Corporation, Tokyo (JP)

(72) Inventor: Masahide TAKAZAWA, Hachioji Tokyo (JP)

(21) Appl. No.: 18/820,073

(22) Filed: Aug. 29, 2024

(30) Foreign Application Priority Data
Mar. 5, 2024 (JP) 2024-032608

(51) Int. Cl. G11B 33/12; G11B 5/82; G11B 33/02; H01R 12/70; H01R 12/72; H01R 13/621

(52) U.S. Cl. CPC G11B 33/126; G11B 5/82; G11B 33/022; H01R 12/7076; H01R 12/721; H01R 13/621

(57) ABSTRACT

According to one embodiment, a disk apparatus includes plural magnetic disks, a spindle motor that rotates the plural magnetic disks, and a housing. The housing has a bottom wall to which the spindle motor is attached and a side wall molded integrally with the bottom wall. Further, the disk apparatus includes a first board attached to the side wall and a first connector attached to the first board for connection with an external device. The first connector has a housing portion with a first surface at least partially facing the bottom wall and a second surface crossing the first surface and a contact portion provided in contact with at least one of the first surface and the second surface, and the contact portion has one end for electric connection with the external device and the other end provided immediately below the first connector.

### CROSS-REFERENCE TO RELATED APPLICATION(S)

This application is based upon and claims the benefit of priority from Japanese Patent Application No. 2024-032608, filed Mar. 5, 2024, the entire contents of which are incorporated herein by reference.

### FIELD

Embodiments described herein relate generally to a magnetic disk apparatus.

### BACKGROUND

In a disk apparatus such as a hard disk drive (HDD), electronic components such as plural magnetic disks, a spindle motor (SPM), and a head assembly are housed in a housing. On the bottom surface of the housing, the electronic components housed in the housing and a printed circuit board (PCB) electrically connectable to an external device to be connected to the HDD are mounted.

With an increase in the capacity of the HDD, the thickness of the housing increases. Accordingly, the area of the side surface of the housing can also be used as a PCB mount surface, and therefore, a flexible design in which the mount surface can be selected according to product specifications is desirable.

### DESCRIPTION OF THE DRAWINGS

FIG. 1 shows a perspective view of an HDD according to a first embodiment.

FIG. 2 shows a plan view of the HDD according to the first embodiment.

FIG. 3 shows a perspective view of an I/F connector.

FIG. 4 shows an X-Z plan view of the HDD according to the first embodiment.

FIGS. 5 and 6 are each a cross-sectional view of one example of the first embodiment taken along line A-A′ in FIG. 4.

FIG. 7 is a cross-sectional view of the first embodiment taken along line B-B′ in FIG. 4.

FIG. 8 shows an X-Z plan view of an HDD according to a second embodiment.

FIG. 9 shows a cross-sectional view of the second embodiment taken along line B-B′ in FIG. 8.

### DETAILED DESCRIPTION

Embodiments provide a disk apparatus, such as an HDD, including a connector disposed on a PCB on a side surface of a housing.

In general, according to one embodiment, a disk apparatus includes plural magnetic disks, a spindle motor that rotates the plural magnetic disks, and a housing. The housing has a bottom wall to which the spindle motor is attached, and a side wall molded integrally with the bottom wall. Further, the disk apparatus includes a board attached to the side wall and a connector attached to the board. The connector has a housing portion with a first surface at least partially facing the bottom wall and a second surface crossing the first surface and a contact portion provided in contact with at least one of the first surface and the second surface, and the contact portion has one end for electric connection with an external device and the other end on a side of the connector away from the bottom wall.

Hereinafter, embodiments of the present disclosure will be described with reference to the drawings. In this description, common elements are denoted by common reference signs throughout the drawings. As shown in each drawing, an X axis, a Y axis, and a Z axis are defined for the sake of convenience in the present specification. The X axis, the Y axis, and the Z axis are orthogonal to each other. When an HDD 10 is in a rectangular shape, the X axis is provided along the short side direction of the HDD 10, and the Y axis is provided along the long side direction of the HDD 10. The Z axis is provided along the thickness direction of the HDD 10.

For the sake of description, a Z direction from a top cover (not shown) to a bottom wall of the HDD 10 will be referred to as “upper” or a “+Z direction”, and the opposite direction thereof will be referred to as “lower” or a “−Z direction”.

The present embodiments do not limit the scope of the present disclosure and dimensions and ratios in the drawings are not limited to those shown in the drawings.

### First Embodiment

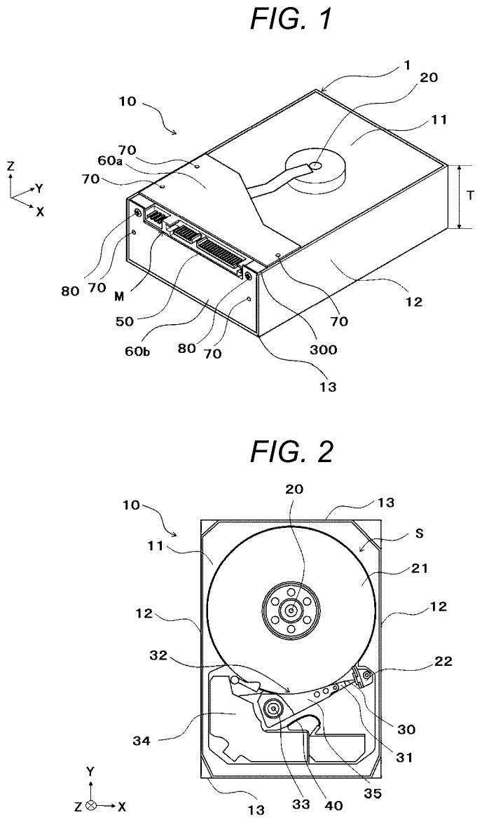

FIG. 1 is a perspective view showing an example of the HDD 10 according to a first embodiment.

As shown in FIG. 1, a housing 1 of the HDD 10 is configured such that a bottom wall 11 and side walls 12, 13 standing in the Z direction from peripheral edge portions of the bottom wall 11 are integrally molded. For the bottom wall 11 and the side walls 12, 13, for example, an alloy material such as aluminum is used.

The side wall 12 is provided to extend in the Y direction along the length of the HDD 10, and the side wall 13 is provided to extend in the X direction along the width of the HDD 10.

A first PCB 60a which is a mount board is provided on the bottom wall 11 of the housing 1, and a second PCB 60b is provided on the side wall 13.

Each of the first PCB 60a and the second PCB 60b has plural attachment portions 70, and is fixed to the housing 1 with metal fittings such as screws. An interface (I/F) connector 50 for connecting the HDD to an external device is further mounted on the second PCB 60b fixed to the side wall 13.

The I/F connector 50 is fixed, at both end portions thereof, to the second PCB 60b and the housing 1 with screws 80. That is, the HDD 10 is configured such that the second PCB 60b, the I/F connector 50, and the housing 1 are provided in this order in the Y direction.

The I/F connector 50 according to the present embodiment is a connector that conforms to at least one of a serial ATA (SATA) standard or a serial attached SCSI (SAS) standard. The I/F connector 50 may be a connector that conforms to other standards.

The I/F connector 50 is located in the vicinity of a boundary between the bottom wall 11 and the side wall 13. That is, the I/F connector 50 is provided at a corner portion of the housing 1 at which the I/F connector 50 and the bottom wall 11 are closest to each other. The I/F connector 50 may be at the location of an I/F connector specified in the SATA standard or the SAS standard.

A first opening M of the I/F connector 50 faces outward of the side wall 13. A receptacle connector in which the first opening M is exposed to the outside, such as in the I/F connector 50, is used in combination with a plug connector to be inserted into the first opening M, such that two types of electric connectors are used in combination.

The HDD 10 is connected to the external device (not shown), and in this case, the I/F connector 50 is connected to a plug connector mounted on the external device. The plug connector is inserted into and detached from the I/F connector 50 in the length direction (Y direction) of the HDD 10.

The HDD 10 of the present embodiment is a 3.5 inch HDD. The thickness T of the HDD 10 according to the present embodiment is greater than 26.1 mm which is the general thickness of the 3.5 inch HDD, and for example, is set to be about 53 mm. The thickness T is not limited to this particular number.

FIG. 2 is a plan view of the HDD 10 according to the first embodiment. For the sake of description, the top cover is omitted.

As shown in FIG. 2, the HDD 10 has an inner chamber S formed by the bottom wall 11 and the side walls 12, 13. The inner chamber S houses a magnetic disk 21 that magnetically records information, a spindle motor (SPM) 20, a carriage assembly 32, a ramp member 22, a voice coil motor (VCM) 34, and a flexible printed circuit (FPC) 40.

The SPM 20 is attached to the bottom wall 11, and functions as a drive motor. The magnetic disk 21 includes plural magnetic disks 21, and is supported and rotated by the SPM 20.

The carriage assembly 32 is supported so as to move relative to the magnetic disk 21, and is rotated and positioned by the VCM 34.

The carriage assembly 32 is provided with a magnetic head 30, and the magnetic head 30 records information in the magnetic disk 21 and reproduces information from the magnetic disk 21.

The ramp member 22 holds the magnetic head 30 at a retreat location apart from the magnetic disk 21 after the magnetic head 30 has moved to the outermost periphery of the magnetic disk 21.

The plural magnetic disks 21, e.g., ten magnetic disks 21, are provided in the Z direction in the HDD 10. The magnetic disks 21 are not limited to the ten disks, and may be nine or less or 11 or more.

The diameter of the magnetic disk 21 is set, for example, to 80 mm or more and 100 mm or less. Specifically, the diameter is set to about 96 mm. The diameter of the magnetic disk 21 is not limited to this example.

The carriage assembly 32 includes a bearing portion 33, an arm 35 extending from the bearing portion 33, and an elastically-deformable elongated plate-shaped suspension 31 fixed to the tip end of the arm 35.

The suspension 31 includes a leaf spring, and the base end thereof is fixed to the tip end of the arm 35 by, e.g., spot welding or swaging and extends from the arm 35. The magnetic head 30 is attached to the suspension 31.

When power is supplied to the VCM 34, the carriage assembly 32 turns with the bearing portion 33 as an axis, and the magnetic head 30 is moved to a desired location on the surface of the magnetic disk 21 and is positioned at such a location. In this manner, the magnetic head 30 can write information in the magnetic disk 21 or read information from the magnetic disk 21.

A relay connector (not shown) is mounted on the first PCB 60a attached to the housing 1. The relay connector is electrically connected to the SPM 20 and the VCM 34 housed in the inner chamber S, for example, via a connector (not shown) provided on the bottom wall 11. In this manner, the first PCB 60a controls operation of the components housed in the inner chamber S. In the present embodiment, the board that controls operation of the components housed in the inner chamber S may be the second PCB 60b. In this case, the relay connector is mounted, for example, on the second PCB 60b, and is connected to the inner chamber S via a connector provided on the side wall 13.

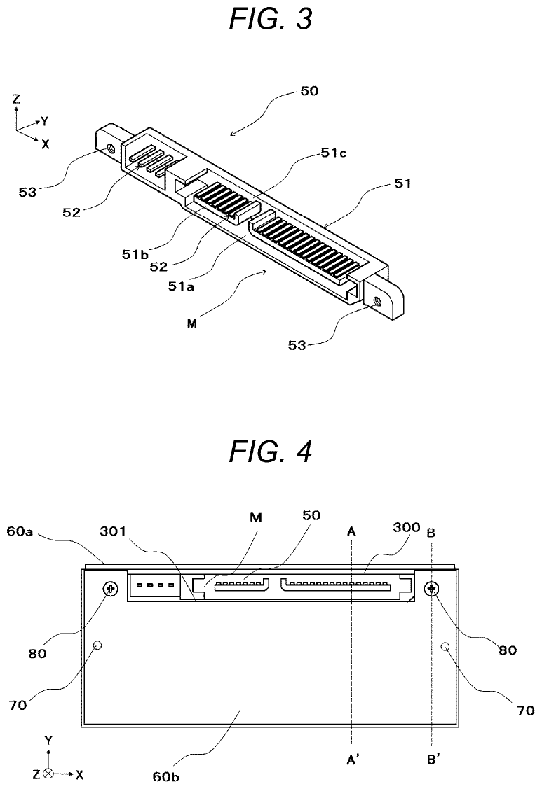

FIG. 3 is a perspective view of the I/F connector 50 according to the first embodiment.

The I/F connector 50 includes a housing portion 51 and plural contact portions 52. The housing portion 51 is made of an insulating material such as resin, and the contact portion 52 is made of a conductive material such as copper.

The housing portion 51 has the first opening M into which the plug connector of the external device is to be inserted.

The first opening M is designed, for example, so as not to protrude from a body of the HDD 10.

Further, the housing portion 51 has a housing bottom portion 51a for supporting a plug connector body when the plug connector fitted in the housing portion 51.

Further, the housing portion 51 has a housing extending portion 51b for maintaining a state of the plug connector being fitted in the housing portion 51 and maintaining an electric connection state. The housing extending portion 51b is provided apart from the housing bottom portion 51a in the Z direction. The plug connector is provided between the housing bottom portion 51a and the housing extending portion 51b.

The housing bottom portion 51a and the housing extending portion 51b at least partially face the bottom wall 11.

The plural contact portions 52 are arranged in the X direction on the housing extending portion 51b.

The contact portion 52 is inserted into and held by a housing back member 51c which is a butting portion when the plug connector is fitted. That is, the housing back member 51c is a portion with which the plug connector contacts when the plug connector is inserted deep into the I/F connector 50. The housing bottom portion 51a and the housing extending portion 51b extend from the housing back member 51c in the-Y direction.

The housing back member 51c crosses the housing bottom portion 51a and the housing extending portion 51b.

The contact portion 52 may be press-fitted and fixed to the housing back member 51c, or may be molded integrally with the housing back member 51c by insert molding.

At both end portions of the I/F connector 50, two attachment portions 53 for fixing the I/F connector 50 with screws are provided. Attachment metal fittings such as the screws 80 are inserted into the attachment portions 53, and are also inserted into attachment holes provided in the second PCB 60b and the housing 1.

FIG. 4 is an X-Z plan view of the HDD 10 according to the first embodiment. FIG. 4 shows a state in which the second PCB 60b on which the I/F connector 50 is mounted is attached to the body of the HDD 10 with the screws 80.

In order to comply with the standard of the HDD, a first recess 300 for housing the I/F connector 50 is provided in the housing 1 such that the I/F connector 50 does not protrude from the housing 1 of the HDD 10. The first recess 300 has, for example, a shape corresponding to the outer shape of the I/F connector 50. Part of the side wall 13 forming the first recess 300 supports, for example, both end portions of the I/F connector 50.

Further, a second recess 301 is formed at a location at which the external device side plug connector is to be inserted, in the second PCB 60b.

The attachment portions 53 are located between the second PCB 60b and the side wall 13 of the housing 1, and in FIG. 4, are not visually recognized. On the other hand, the first opening M is visually recognizable through the second recess 301.

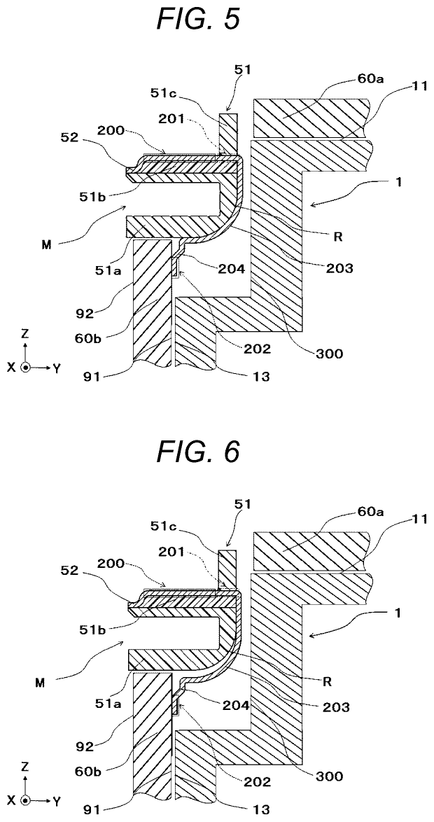

FIG. 5 is a cross-sectional view taken along line A-A′ in FIG. 4, and shows an electric connection state between the I/F connector 50 and the second PCB 60b.

In FIG. 5, the second PCB 60b has a first PCB surface 91 facing the side wall 13 and a second PCB surface 92 which is a surface opposite to the first PCB surface 91, and the I/F connector 50 is mounted on the first PCB surface 91.

As shown in FIG. 5, the housing bottom portion 51a has a curved outer surface shape R.

According to FIG. 5, the contact portion 52 inserted into the housing back member 51c has one end and the other end. The one end of the contact portion 52 has a first connection portion 200 for electric connection with the plug connector at the housing extending portion 51b. The first connection portion 200 is indicated by a dashed line.

The contact portion 52 has a fixed portion 201 fixed by the housing back member 51c. The contact portion 52 is orthogonal to a connector insertion direction in a region adjacent to the fixed portion 201, and is bent in a direction (−Z direction) apart from the bottom wall 11 of the HDD. The fixed portion 201 is indicated by a dash-dotted line.

The bent contact portion 52 has a curved portion 203 bent along the outer surface shape R of the housing portion 51. That is, the curved portion 203 has a curvature greater than zero. The other end of the contact portion 52 is electrically connected to the first PCB surface 91 immediately below the housing bottom portion 51a by a joining member such as solder. Here, immediately below the housing bottom portion 51a indicates an adjacent region extending in the −Z direction from the lowermost surface of the housing bottom portion 51a. For example, immediately below the housing bottom portion 51a indicates a region within one centimeter in the −Z direction from the lowermost surface of the housing bottom portion 51a. A region of the contact portion 52 connected to the second PCB 60b is a second connection portion 202, and is indicated by a dashed line. That is, the other end of the contact portion 52 has the second connection portion 202. The contact portion 52 is configured such that the first connection portion 200 (one end), the fixed portion 201, the curved portion 203, and the second connection portion 202 (other end) are provided in this order and are integrally formed.

The contact portion 52 may have a bent portion 204 bent in a stepwise manner between the curved portion 203 and the second connection portion 202 such that the second connection portion 202 contacts the first PCB surface 91.

Depending on the type of signal, the first connection portion 200 includes one not held by the housing extending portion 51b.

The curved portion 203 of the contact portion 52 may include, for example, one mechanically having spring properties, and one simply bent in a stepwise manner.

The contact portion 52 may be bent in contact with the housing portion 51 along the outer surface shape R of the housing portion 51.

As shown in FIG. 6, the contact portion 52 may be at least partially apart from the outer surface of the I/F connector 50 between the fixed portion 201 and the second connection portion 202.

An electrode pad (not shown) to be connected to the second connection portion 202 is disposed on the first PCB surface 91, and is electrically connected using a joining member such as solder. The electrode pad corresponds to each of the plural contact portions 52. The electric connection method is not limited to soldering, and for example, laser or welding may be used.

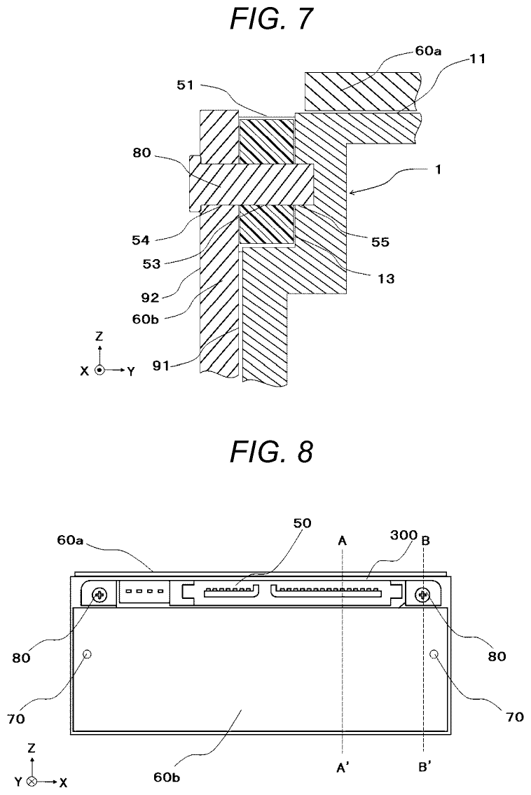

FIG. 7 is a cross-sectional view taken along B-B′ line in FIG. 4, and shows a state of the I/F connector 50 being attached to the body of the HDD 10.

According to FIG. 7, the second PCB 60b is provided with attachment portions 54, and the housing 1 is provided with attachment portions 55. The common attachment metal fittings such as the screws 80 are inserted into the attachment portions 53 provided at both ends of the I/F connector 50 and the attachment portions 54 provided at the second PCB 60b, and are fixed to the attachment portions 55 provided at the housing 1.

### Effects of First Embodiment

Effects of the HDD 10 according to the first embodiment will be described.

In an HDD of the related art, an I/F connector 50 for connection with an external device is mounted on a first PCB 60a mounted on a bottom wall 11, and no PCB is attached to a side wall 13.

The second PCB 60b is provided on the side wall 13 and the I/F connector 50 is mounted thereon as in the present embodiment, so that a PCB mount region can be expanded and an increase in the number of electronic components and an increase in the number of magnetic disks resulting from future HDD performance improvement can be handled.

For example, when the power consumption of the SPM or the VCM has increased due to HDD performance improvement, the number of multi-layer ceramic capacitors (MLCCs) or tantalum capacitors increases.

When such a component having a great height after mounting is mounted on the first PCB 60a so as to face the bottom wall 11, a space for mounting the component needs to be provided inside the HDD. For this reason, a space in the thickness direction (Z direction) of the HDD 10 is narrowed, which limits the mount height of the magnetic disk and interferes with an increase in the number of magnetic disks.

On the other hand, when the component having a great height after mounting is mounted on the second PCB 60b, a space in the longitudinal direction (Y direction) of the HDD is narrowed due to securing a space for mounting the component. In this case, the mount height of the magnetic disk is not limited, which does not interfere with an increase in the number of magnetic disks.

In many cases, such a component having a great mount height is mounted on the same board as that for the I/F connector 50 influencing the power consumption.

For this reason, the I/F connector 50 is mounted on the second PCB 60b so that a region for mounting the component having a great mount height can be expanded and a design that is advantageous in increasing the number of magnetic disks can be achieved.

In a case where the HDD is connected to the external device such as a server, a cooling system is mounted, which leads to a concern about transmission of vibration due to an air-cooling fan to the HDD body.

In the present embodiment, the contact portion 52 has the curved portion 203 or the bent portion 204, and therefore, stress due to the vibration from the server can be absorbed and an effect of avoiding partial stress concentration and an effect of preventing resonance in vibration with a specific frequency can be expected.

Such server vibration leads to a concern about degradation of the function of the HDD body and shortening of the lifetime of the soldered portion, and for this reason, reduction in the vibration also leads to extension of the lifetime of the HDD body.

Further, it can be expected that the curved portion 203 of the contact portion 52 provides an effect of absorbing distortion when the second PCB 60b and the I/F connector 50 are attached to the HDD body and reducing a load on the soldered portion.

In FIG. 6, the curved portion 203 of the contact portion 52 has a structure of being at least partially apart from the outer surface of the I/F connector 50. Since the curved portion 203 is apart from the I/F connector 50 in the vicinity of the soldered portion of the contact portion 52, the above-described effects are more easily obtainable.

For example, it may be configured such that the contact portion 52 and a partial surface of the housing bottom portion 51a facing the bottom wall does not contact each other. With this configuration, the entire length of the contact portion 52 is increased, which is effective in absorbing the stress due to the vibration.

### Second Embodiment

Hereinafter, a second embodiment will be described with reference to FIG. 8. In the following description of plural embodiments, elements having functions similar to those of the elements already described are denoted by the same reference signs as those of the already-described elements and description thereof may be omitted.

FIG. 8 is an X-Z plan view of the HDD 10 according to the second embodiment.

The second embodiment is different from the first embodiment in that the attachment portions 53 of the I/F connector 50 are fixed to the housing 1 without also being attached to the second PCB 60b.

In the second embodiment, the second PCB 60b has the attachment portions 70, and is fixed to the housing 1.

The state of connection between the I/F connector 50 and the second PCB 60b is similar to that in the first embodiment, and therefore, FIG. 5 is a cross-sectional view taken along line A-A′ in FIG. 8.

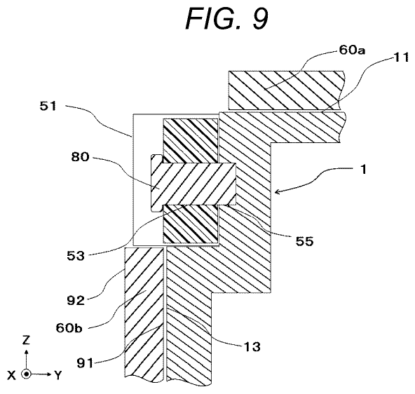

FIG. 9 is a cross-sectional view taken along line B-B′in FIG. 8, and shows a state of the I/F connector 50 being attached to the HDD body.

According to FIG. 9, the I/F connector 50 is not fixed to the HDD 10 with the screws causing the second PCB 60b to press the I/F connector 50 against the HDD 10, but is directly fixed to the HDD 10 with the screws.

### Effects of Second Embodiment

Effects of the HDD 10 according to the second embodiment will be described. expected.

In the present embodiment, effects similar to those in the first embodiment can be

As compared to the first embodiment, the vibration of the external device is less likely to be directly transmitted to the second PCB 60b via the I/F connector 50. That is, the vibration of the external device received by the I/F connector 50 is directly absorbed by the curved portion 203 or the bent portion 204 of the contact portion 52. The HDD 10 according to the second embodiment can absorb the stress due to the vibration from the external device, and an effect of avoiding partial stress concentration and an effect of preventing resonance in vibration with a specific frequency can be expected.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A disk apparatus comprising:
plural magnetic disks;
a spindle motor that rotates the plural magnetic disks;
a housing having
a bottom wall to which the spindle motor is attached, and
a side wall molded integrally with the bottom wall;
a board attached to the side wall; and
a connector attached to the board, wherein
the connector has
a housing portion having a first surface at least partially facing the bottom wall and a second surface crossing the first surface, and
a contact portion provided in contact with at least one of the first surface or the second surface, and
the contact portion has
a first end for electric connection with an external device, and
a second end provided on a side of the connector away from the bottom wall.

2. The disk apparatus according to claim 1, wherein the connector is a connector that conforms with at least one of a SAS standard and a SATA standard.

3. The disk apparatus according to claim 1, wherein the contact portion further has a curved portion between the first end and the second end.

4. The disk apparatus according to claim 3, wherein the contact portion further has a bent portion between the curved portion and the second end.

5. The disk apparatus according to claim 1, wherein the board has a third surface facing the side wall, and the connector is electrically connected to the third surface with solder.

6. The disk apparatus according to claim 1, wherein the board is provided with a first recess in which the connector is disposed.

7. The disk apparatus according to claim 1, wherein each longitudinal end of the connector has an attachment portion into which a screw is to be inserted.

8. The disk apparatus according to claim 7, wherein the attachment portion is located between the board and the housing.

9. The disk apparatus according to claim 8, wherein a screw is inserted into the attachment portion and the board, and is fixed to the housing.

10. The disk apparatus according to claim 7, wherein the connector is directly fixed to the housing with the screw inserted into the attachment portion.

11. A disk apparatus comprising:
plural magnetic disks;
a spindle motor that rotates the plural magnetic disks;
a housing having a bottom wall to which the spindle motor is attached, and a side wall extending in a first direction from the bottom wall;
a printed circuit board (PCB) attached to the side wall; and
a connector having a body with a first surface at least partially facing the bottom wall and a second surface crossing the first surface, and a contact portion, wherein
the contact portion has a first end for electric connection with an external device, and a second end spaced away from the body of the connector in the first direction away from the bottom wall and electrically connected to the PCB.

12. The disk apparatus according to claim 11, wherein the connector conforms with at least one of a SAS standard and a SATA standard.

13. The disk apparatus according to claim 11, wherein the contact portion further has a curved portion between the first end and the second end.

14. The disk apparatus according to claim 13, wherein the contact portion further has a bent portion between the curved portion and the second end.

15. The disk apparatus according to claim 11, wherein the PCB has a third surface facing the side wall, and the connector is electrically connected to the third surface with solder.

16. The disk apparatus according to claim 11, wherein the PCB is provided with a first recess in which the connector is disposed.

17. The disk apparatus according to claim 11, wherein the connector extends in a second direction parallel to a surface of the side wall and perpendicular to the first direction and has an attachment portion into which a screw is to be inserted, at each end thereof in the second direction.

18. The disk apparatus according to claim 17, wherein the attachment portion is located between the PCB and the housing.

19. The disk apparatus according to claim 18, wherein a screw is inserted into the attachment portion and the PCB, and is fixed to the housing.

20. The disk apparatus according to claim 17, wherein the connector is directly fixed to the housing with the screw inserted into the attachment portion.
